(19) United States
(12) Patent Application Publication
(10) Pub. No.: US 2009/0075006 A1
(43) Pub. Date: Mar. 19, 2009

(54) Cleancall

(76) Inventors: Timothy Lynam, Whitehouse Station, NJ (US); Pamela Fusco, Whitehouse Station, NJ (US)

Correspondence Address: BAKER BOTTS L.L.P., 30 ROCKEFELLER PLAZA, 44TH FLOOR, NEW YORK, NY, 10112-4498, US

(21) Appl. No.: 11/856,332

(22) Filed: Sep. 17, 2007

(51) Int. Cl. B32B 7/12; B32B 33/00; B65D 65/28

(52) U.S. Cl. 428/40.1; 428/354; 428/43

(57) ABSTRACT

A multilayered protective covering including a plurality of sanitary/protective layers including a plurality of films coated with a pressure sensitive adhesive, each of the sanitary/protective layers being stacked to form the multilayered protective covering. The layers can be peeled away one from another by a non-adhesive pull-tab during the course of usage.

### BACKGROUND

The disclosed subject matter relates to protective removable adhesive sheets which are used to protect from dirt and debris and ensure cleanliness of telecommunications and other portable devices that come into physical contact with the environment or a person, and more specifically it is a combination of disposable hypoallergenic adhesive clear multiple layers designed to adhere to portable devices such as mobile/home/office phones, television/stereo controllers, ear pieces and related portable devices to reduce bacterial contamination via dirt, cosmetics, germs, oils and other elements.

Portable devices used for communication and/or that are generally used by multiple users enabling the risk of transmission of harmful bacteria, skin infections and viruses among users.

Current methods for reducing the risk of transmission of these pathogens are the use of antibacterial sprays, individually packaged antibacterial towelettes, and covers for the entire handset, for example.

U.S. Pat. No. 6,560,335 describes the recent dramatic increase in the incidence of infection diseases due to pathogen contamination, of communication portable devices in particular, and discloses several solutions. Among them are hat-like covers made of sound-permeable materials fastened to the telecommunication by a variety of means, and a single-sheet cover including a band of adhesive material.

U.S. Pat. No. 5,054,063 discloses a sound-permeable multi-layer cover sheet. The sheet includes a layer of soft fabric bonded to a layer of water impermeable material using an adhesive layer.

U.S. Pat. No. 4,953,703 discloses a stack of protective elements and separating sheets retained along one side by a plurality of staples, pins with depressible legs, or by a thermoadhesive strip.

Unfortunately, all of the aforementioned sanitary covers are too cumbersome to use and to manufacture and do not fit the wide array of portable devices like this particular multilayered protective covering. Accordingly, there remains a dire need for a multi-use disposable one-dimensional, simplistic, economical and stylish multilayered protective covering.

### SUMMARY

“CleanCall”, a hygienic multi purpose multilayered protective covering suited for mobile communications and other peripheral portable devices is disclosed herein.

The disclosed subject matter provides a hygienic multilayered protective covering that includes a plurality of sanitary layers including a plurality of films coated with a pressure sensitive adhesive, each of the sanitary layers being stacked to form the multilayered protective covering.

In some embodiments, each of the sanitary layers includes at least a perforation if required for audio and voice communications and each of the plurality of layers is disk-shaped or rectangular in shape according to the portable device that it will adhere to.

The accompanying drawings, which are incorporated and constitute part of this disclosure, illustrate preferred embodiments of the disclosed subject matter and serve to explain its principles.

### BRIEF DESCRIPTION OF THE DRAWINGS

FIG. 1 is a diagram illustrating a multilayered protective covering in accordance with an embodiment of the disclosed subject matter; and

FIG. 2 is another diagram illustrating a multilayered protective covering in accordance with another embodiment of the disclosed subject matter.

While the disclosed subject matter will now be described in detail with reference to the drawings, it is done so in connection with the illustrative embodiments.

### DETAILED DESCRIPTION

A hygienic telecommunication/portable device with a multilayered protective covering is disclosed herein. The disclosed subject matter provides a hygienic telecommunication/portable device with a multilayered protective covering that includes a plurality of sanitary layers including a plurality of films coated with a pressure sensitive adhesive, each of the sanitary layers being stacked to form the multilayered protective covering.

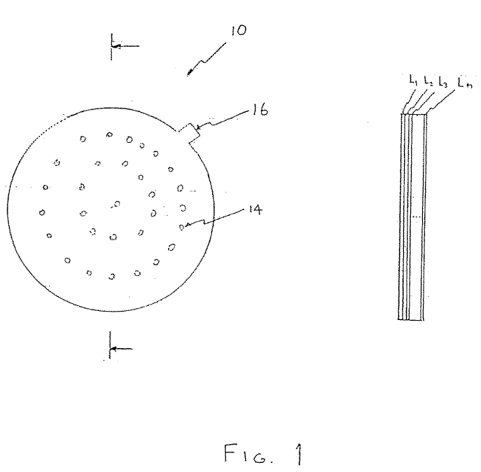

FIG. 1 is a diagram illustrating a multilayered protective covering in accordance with an embodiment of the disclosed subject matter. In a preferred embodiment, the multilayered protective covering 10 is formed by stacking sanitary layers L₁, L₂, L₃, . . . Lₙ made of a clear polyester film single coated with a hypoallergenic pressure sensitive acrylate adhesive.

The multilayered protective covering 10 is attached to the mouthpiece, earpiece, control area, calling area of portable devices such as telephones, cellular telephones, personal digital assistants (PDAs), TV/stereo controllers, hospital machinery controllers, etc. by using the adhesive layer of the last layer Lₙ of the multilayered protective covering 10. A layer from the multilayered protective covering 10 is easily pulled off from the underlying one by a non-adhesive tab 16 formed therein, without pulling off all the layers of the multilayered protective covering, because of the stronger adherence of the layer contacting the portable device which is typically made of a polycarbonate material.

An advantage of the aforementioned features of the multilayered protective covering 10 is that with the removal of each layer L₁, L₂, L₃, . . . Lₙ, the pathogens that were deposited by the user are eliminated without having to use a disinfectant spray, for example.

FIG. 1 shows an example of a multilayered protective covering 10 having a disk shape. However, there is no limitation to shapes in which it may be formed/molded such as rectangular, square, or of any other shape to accommodate the configuration of the area of the portable device where the protection of the multilayered protective covering 10 is desired. For well known configurations, such as flip-type cell phones, blackberry portable devices, home and office telecommunications, etc, the material is pre-formed from the manufacturer. Other portable devices can be protected by a universal multilayered protective covering and cut down to the exact shape of the device.

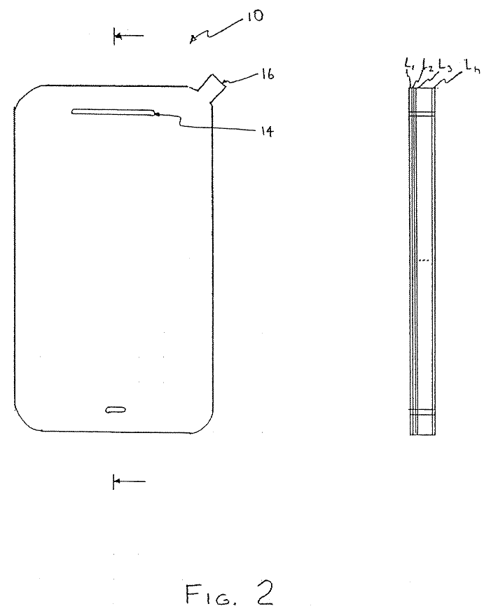

FIG. 2 shows an example of a multilayer protective covering 10 having a rectangular shape for use on a PDA, for example.

To prevent distortion of audio/voice waves, in a preferred embodiment, one or more perforations/openings/slits 14 are formed in the multilayered protective covering 10.

In an embodiment of the present invention, the multilayered protective covering 10 can be formed by using 3 to 5 layers of 2.3 mil clear polyester medical tape such as medical single coated film tape # 1516 manufactured by 3M® for fold-type phones, due to space limitations, and up to 10 layers for non-folding portable devices. Layers of about half the thickness would be preferred to allow for a thinner multilayered protective covering such as a 1.5 mil clear polyester medical tape, single coated film tape manufactured by 3M®. The tape is inherently elastic and does not interfere with the operation of the keys of the device.

The multilayered protective covering 10 can be sold with the portable device with the possibility of buying replacements as desired. This type of multilayered protective covering is distinctly different from previously proposed pads, in that the covering is clear, is not even noticeable when applied, and it does not impede the functioning of the device. It is easily applied and just as easily each layer is stripped from the underlying layer to present a new surface free of dirt, debris and germs for a new user. The multilayered protective covering fits multiple communication portable devices at home, work or on the road as well as any type of TV or stereo controllers and even multiple use machines that need to be protected in a hospital/industrial environment.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

What is claimed is:

1. A multilayered protective covering comprising:
a plurality of sanitary layers including a plurality of films coated with a pressure sensitive adhesive, and
each of the sanitary layers being stacked to form the multilayered protective covering.

2. The multilayered protective covering according to claim 1, wherein each of the sanitary layers includes a perforation.

3. The multilayered protective covering according to claim 2, wherein the pressure sensitive adhesive is a clear/transparent acrylate adhesive.

4. The multilayered protective covering according to claim 3, wherein each of the plurality of films is formed of polyester.

5. The multilayered protective covering according to claim 4, wherein each of the plurality of layers is 1.5 mils to 2.3 mils thick.

6. The multilayered protective covering according to claim 4, wherein each of the plurality of films is disk-shaped.

7. The multilayered protective covering according to claim 4, wherein each of the plurality of films is rectangular in shape.

8. The multilayered protective covering according to claim 4, wherein each of the plurality of films is form shaped to fit a portable device.

9. The multilayered protective covering according to claim 2, wherein the perforation is circular in shape.

10. The multilayered protective covering according to claim 2, wherein the perforation is slit-shaped.

11. The multilayered protective covering according to claim 4, wherein the covering is custom shaped by a user.

12. The multilayered protective covering according to claim 4, wherein each of the plurality of films includes a non-adhesive tab for ease of removal.
